(19) United States
(12) Patent Application Publication
(10) Pub. No.: US 2016/0053476 A1
(43) Pub. Date: Feb. 25, 2016

(54) MULTI-USE PORTABLE ENCLOSURE

(71) Applicant: George Chrzanowski, Corrales, NM (US)

(72) Inventor: George Chrzanowski, Corrales, NM (US)

(21) Appl. No.: 14/462,752

(22) Filed: Aug. 19, 2014

(51) Int. Cl. E04B 1/344; G05B 11/01; B60D 1/48; E04B 1/343; E04B 7/16

(52) U.S. Cl. CPC E04B 1/344; E04B 1/34336; E04B 1/34384; E04B 7/163; B60D 1/48; G05B 11/01

(57) ABSTRACT

A multi-use enclosure including an upper portion connected to a lower portion to create an enclosure of a size and shape to accommodate a motor vehicle. The lower section may contain a ballast compartment and an axle, as well as a power storage device in order to power electrical components of the enclosure. The enclosure may also include a control unit and a communication unit connected to the power storage device and to a network in order to receive and transmit information to a remote device connected to said network. Sensors configured to detect the position of a vehicle or conditions of the enclosure may provide the information to be transmitted by the communication unit.

### FIELD OF THE INVENTION

Embodiments disclosed herein generally relate to a self-contained motor vehicle enclosure. Embodiments are also related to a portable garage structure being configured for use as a trailer, camping trailer, and/or watercraft.

### BACKGROUND

Protecting a motor vehicle from environmental hazards, such as sunlight or hail, has typically involved parking it within or under a permanent structure OF by covering the vehicle with a flexible material. There are substantial drawbacks to both methods. A permanent structure may not be feasible in some cases where space is limited or permanent altering of a space by construction of a building or covering is not allowed. Likewise, car covers made of material may be impractical and ineffective in areas subject to high winds and may not provide for adequate protection from damaging weather, such as hail. While pre-fabricated, temporary structures may also be employed to provide protection for a vehicle, they often suffer from structural weaknesses and are not easily re-locatable and are not configured for multi-use applications. As such, a need exists for a portable vehicle enclosure that does not require permanent anchoring, but is durable and can provide sufficient protection from the elements, while also being configured for multi-use applications.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved multi-use enclosure that is portable.

It is a further aspect of the disclosed embodiments to provide for an improved method of making a multi-use enclosure that is portable.

The aforementioned aspects and other objectives and advantages can be achieved as described herein. The enclosure includes an upper portion connected to a lower portion that includes a ballast compartment. The lower portion may also include a power storage device, a control unit, and a communication unit. A method of making such an enclosure includes connecting an upper portion to a lower portion having a ballast compartment and an axle. A power storage device may also be connected to the lower portion to provide power to a control unit and a communication unit.

Other objects, features, and advantages of the present invention will become readily apparent from the following detailed description of the preferred embodiment when considered with the attached drawings and the appended claims.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a side view of an embodiment of a portable enclosure;

FIG. 2 illustrates an alternate embodiment of the enclosure;

FIG. 3 illustrates a side perspective view of an embodiment of the lower portion of the enclosure;

FIG. 4 illustrates an embodiment of the enclosure having an upper portion configured for multi-use applications; and

FIG. 5 illustrates an embodiment of the enclosure having an upper portion configured to receive flexible supports and material.

### DETAILED DESCRIPTION

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein. Rather, these embodiments are provided so that this disclosure will be thorough and complete and will fully convey the scope of the invention to those skilled in the art. Unnecessary detail of known functions and operations may be omitted from the current description so as not to obscure the present invention. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

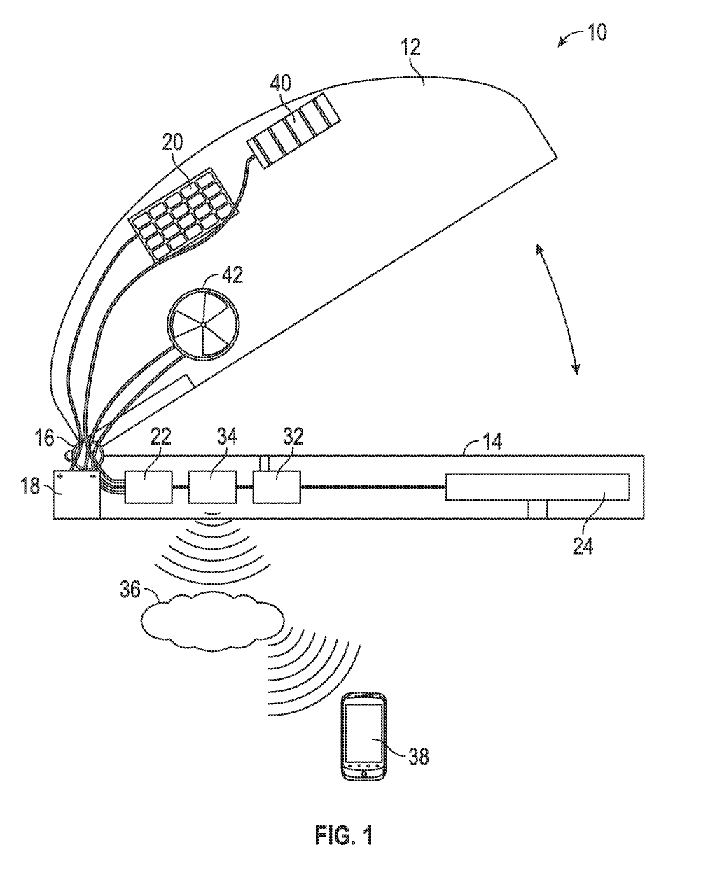

FIG. 1 illustrates a side view of an embodiment of a portable vehicle enclosure 10. The enclosure 10 has an upper portion 12 coupled to a lower portion 14 so as to allow the upper portion 12 to be lifted upwards and away from the lower portion 14. The upper 12 and lower 14 portions are of a size so as to accommodate a motor vehicle, such as a car, truck or motorcycle. The lower portion 14 is substantially flat or platform-like with a length and a width to allow for placement of a motor vehicle atop the lower portion 14. The upper portion 12 may be curved or otherwise formed so as to be of a size and shape capable of fitting over a motor vehicle. The upper portion 12 is coupled to the lower portion 14 via a hinge mechanism 16 that allows one end of the upper portion 12 to swing upwards and away from the lower portion 14 while the other end of the upper portion 12 remains coupled to the lower portion 14. While FIG. 1 illustrates the hinge mechanism 16 being located at the front of the enclosure such that the length of the upper portion 12 swings away from the lower portion 14, the hinge mechanism 16 may alternatively be located along the side of the enclosure such that the width of the upper portion 12 would swing away from the lower portion 14 to allow a vehicle to be positioned atop the lower portion 14. The hinge mechanism 16 can include a spring and counterweight to assist in the manual lifting and closing of the upper portion 12. The hinge mechanism 16 may also include electronic components or hydraulic components to lift the upper portion 12.

Additionally, the enclosure 10 can include a power storage device 18, such as a re-chargeable battery, connected to and configured to power any electrical components of the enclosure 10, as well as a plug (not shown) in order to connect the electrical components of the enclosure to an external power source. An electricity generating device 20, such as solar panel or wind generator, may be connected to the power storage device 18 so as to recharge the power storage device 18 such that no external power source is necessary to run any electrical components. The electricity generating device 20 may be mounted to or incorporated into the upper portion 12 of the enclosure 10. In one embodiment, a control unit 22 is included and configured to control electrical components of the enclosure 10 and to allow for remote control operation of the hinge mechanism 16. The enclosure 10 may also include a communication unit 34, such as a transmitter/receiver or a built-in web server, operably connected to the control unit 22 and configured to send and/or receive information over a network 36, such as a cellular or wireless network. The communication unit 34 is configured to allow a user to operate electronic components of the enclosure 10 utilizing any device 38 connected to the network 36, such as a cellular telephone or computer. The communication unit 34 may also be configured to send notifications to a device 38 connected to the network 36.

Vents 40 can be integrated into the upper portion 12 to provide ventilation to the inside of the enclosure 10. The vents 40 may be passive or controlled electronically via the control unit 22. A heating/cooling unit 42 may also be integrated into the enclosure 10 and operably connected to the control unit 22 and power storage device 18 in order to provide heating or cooling to the interior of the enclosure 10.

To make the enclosure 10 portable (i.e., towable by a vehicle), the upper 12 and lower 14 portions are formed from lightweight materials, such as fiberglass, aluminum, carbon fiber, plastic, canvas, fabric, ripstop or any other lightweight, durable material. In order to allow for the addition of extra weight when the enclosure is not being transported, the lower portion 14 can include at least one ballast compartment 24 configured to hold water, sand or other materials. The ballast compartment 24 may also include a plug/drain assembly to allow for emptying of the compartment 24 prior to moving the enclosure. The ballast compartment 24 may be integrated or formed as part of the lower portion 14 or, alternatively, may be separate and removable from the lower portion 14. The ballast compartment 24 may also be configured from materials having a density lower than that of water, such as Styrofoam, so as to provide floatation for the enclosure 10 in the event of a flood.

In one embodiment, the enclosure 10 can include an air compressor 32 operably connected to the control unit 22 and to the ballast compartment 24. The air compressor 32 can provide air to the ballast compartment in order to clear it of water or sand and to fill the ballast compartment 24 with compressed air to provide floatation for the enclosure 10 in the event of a flood. The air compressor 32 may also be configured to provide air to the inside of the enclosure 10 via ducts or vents in order to aid in ventilation.

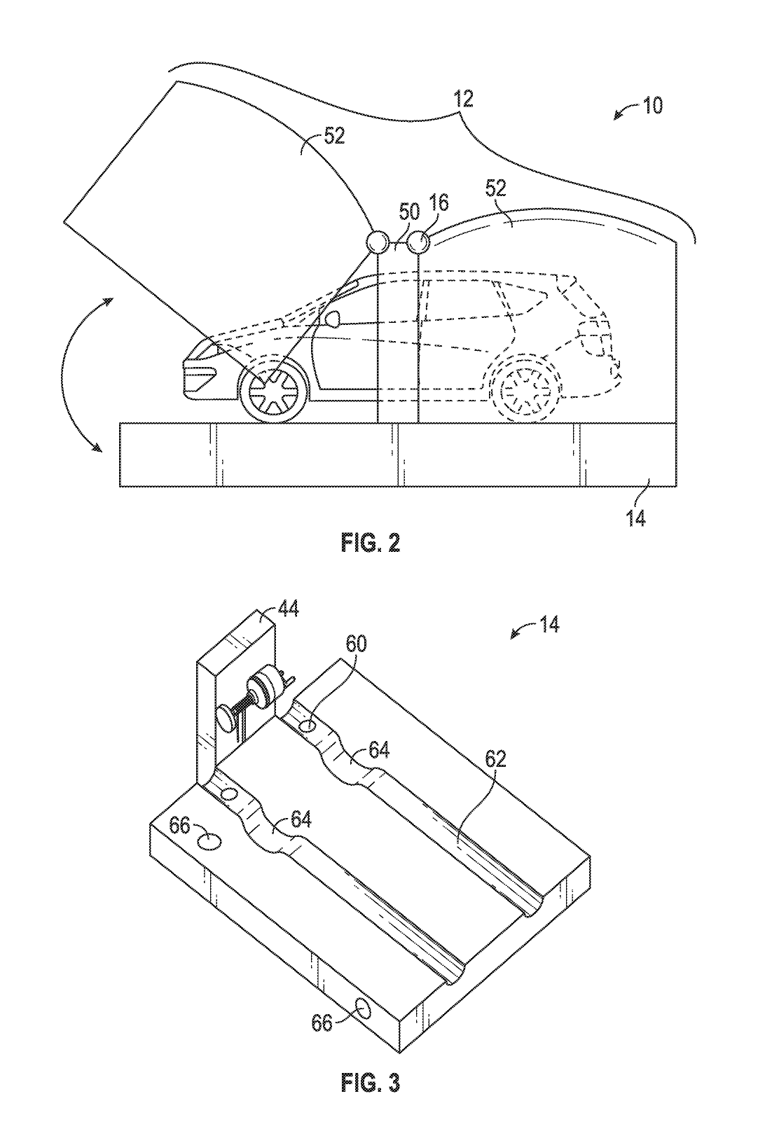

FIG. 2 illustrates an alternate embodiment of the enclosure 10. In the illustrated embodiment, the upper portion 12 consists of a center member 50 connected to two half-shell sections 52 by hinge mechanisms 16. The center member 50 may be configured as an arch across the lower portion 14 of the enclosure such that when the two half-shell sections 52 are lowered into contact with the lower portion 14, they align with the center member 50 to form a continuous upper portion 12.

FIG. 3 illustrates a side perspective view of an embodiment of the lower portion 14 of the enclosure 10. To facilitate use of the enclosure 10 for vehicle protection, position sensors 60 can be provided on the lower portion 14, and operably connected to the control unit 22, to aid the driver of a vehicle in correctly positioning the vehicle within the enclosure 10 so as to allow the upper portion 12 to be lowered over the vehicle without contacting the vehicle. The position sensors 60 may be placed within tracks 62 or elsewhere on the lower portion 14 so as to sense the position of the tires of a vehicle or the vehicle itself. Position sensors 60 may also be provided on the upper portion 12 of the enclosure 10 in addition to, or instead of, the sensors 60 on the lower portion 14. The position sensors 60 may be configured to provide audio and/or visual feedback to a driver regarding the position of the vehicle within the enclosure 10. For example, the position sensors 60 may be operably connected to a light positioned within the enclosure 10 which would illuminate when the vehicle had reached the appropriate position in order to indicate to the driver to stop. Likewise, the position sensors 60 may be operably connected to a speaker which would emit an audible noise when the vehicle had reached the appropriate position within the enclosure 10. The tracks 62 of the lower portion 14, into which tires of a vehicle would fit in order to aid the driver in correctly positioning the vehicle within the enclosure 10, may be of a uniform depth along their length or may have a slightly deeper recessed section or dip 64 into which a tire could descend so that a driver could feel when the vehicle had reached the appropriate position within the enclosure 10. Additionally, the enclosure 10 may include a winch system 44 that is capable of pulling a vehicle onto the lower portion 14 of the enclosure without the assistance of a driver or the need for power from the vehicle itself.

Also illustrated in FIG. 3 are condition sensors 66 located on the lower portion 14 of the enclosure, and operably connected to the control unit 22. Condition sensors 66 can also be provided on the upper portion 12 of the enclosure. The condition sensors 66 can be positioned on interior or exterior of the upper portion 12 and on the top, bottom, and/or sides of the lower 14 portion. The condition sensors 66 can be configured to detect water, temperature, and other conditions of the enclosure 10, such as whether the upper portion 12 has been raised or tampered with. Upon the detection of certain conditions by the condition sensors 66, the control unit 22 may cause the communication unit 34 to convey a notification to a device 38 associated with the network 36. Additionally, the control unit 22 may automatically respond to certain conditions. For example, if water is detected by the condition sensors 66, the control unit 22 can automatically direct the air compressor 32 to start pumping air into the ballast compartment 24 in order to provide floatation for the enclosure 10 or if the condition sensors 66 detect temperatures in excess of a predefined threshold, the control unit 22 can automatically open the vents 40 and direct the air compressor 32 to pump air into the interior of the enclosure 10 to help reduce the temperature. Likewise, the control unit 22 can cause the heater/cooler unit 42 to begin operation if temperatures are detected by the condition sensors 66 that are above or below predetermined thresholds.

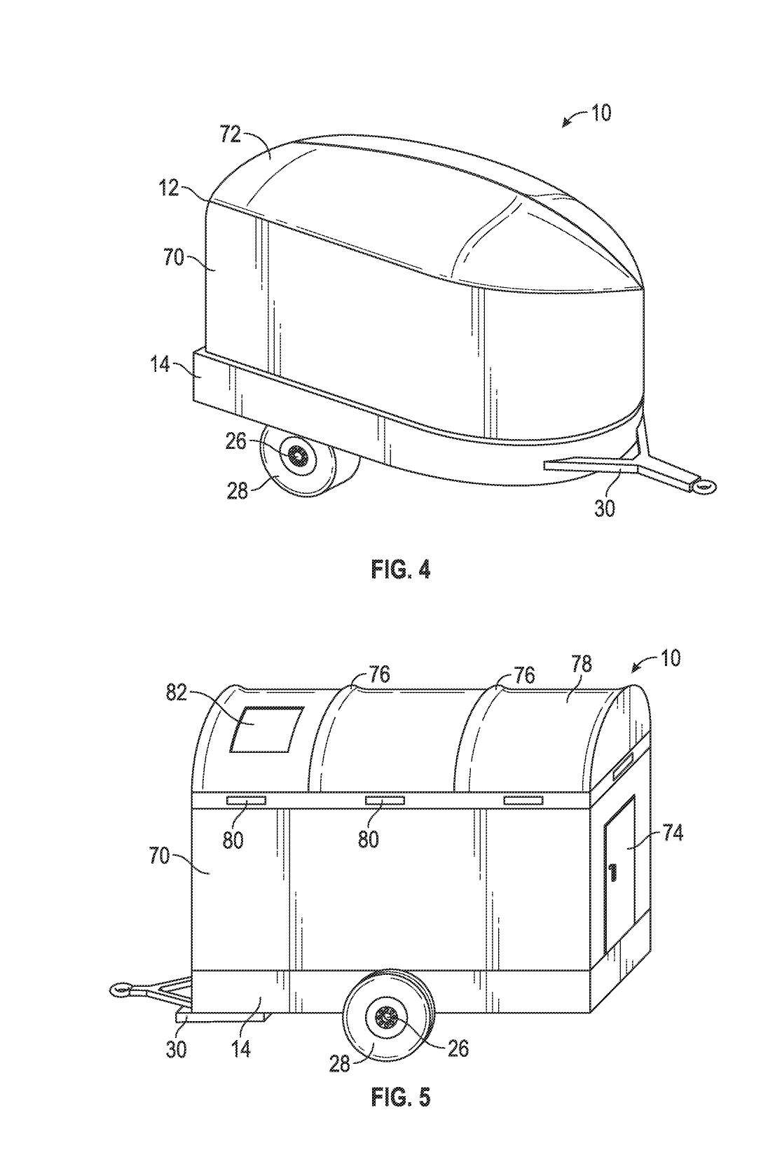

FIG. 4 illustrates an embodiment of the enclosure 10 having an upper portion 12 configured for multi-use applications. In one embodiment, the upper portion 12 is composed of a wall section 70 and a roof section 72. The wall section 70 is removably connected to the lower portion 14 of the enclosure and may contain a door 74. The roof section 72 is removably connected to the top of the wall section 70. The roof section 72 may be of a size and shape such that it will accommodate at least one person when removed from said wall section 70 and float when placed in water up-side down. Thus, the roof section 72 is configured to also serve as a watercraft.

As also illustrated in FIG. 4, the lower portion 14 can include an axle 26 with removable wheels 28 and a removable hitch 30 so that the enclosure 10 may be towed behind a vehicle. In order to provide for use in applications other than vehicle protection, the upper portion 12 may be fully removable from the lower portion 14 to create a flat-bed trailer.

As shown in FIG, 5, the wall section 70 can be configured to receive flexible supports 76, such as tent poles, and flexible material 78, such as tent canvas or nylon, when the roof section 72 is removed so as to create a temporary roof for the enclosure 10. The flexible material 78 may optionally be secured to the wall section 70 by a fastening means 80, such as Velcro®, snaps, or a loop and hook pairing. Windows or openings 82 can also be integrated into the flexible material 78. Such a configuration allows for use of the enclosure 10 as a portable camping enclosure and/or watercraft.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A multi-use enclosure comprising:
an upper portion operably connected to a lower portion;
a ballast compartment integrated into said lower portion;
a power storage device operably connected to said lower portion;
a control unit operably connected to said power storage device and to a network; and
a communication unit operably connected to said control unit and said network, said communication unit being configured to receive and transmit information to a remote device operably connected to said network.

2. The multi-use enclosure of claim 1 wherein said upper portion comprises a roof section removably connected to a wall section, wherein said roof section is of a shape and size that allows for floatation when flipped up-side down.

3. The multi-use enclosure of claim 1 wherein said upper portion comprises a center member connected to said lower portion and to two half-shell sections via hinge mechanisms such that each half-shell section may be raised away from said lower section while remaining connected to said center member.

4. The multi-use enclosure of claim 1 further comprising a heating/cooling unit configured to provide heating and/or cooling to the interior of said multi-use enclosure.

5. The multi-use enclosure of claim 1 further comprising an electricity generating device mounted to said upper portion and operably connected to said power storage device.

6. The multi-use enclosure of claim 1 further comprising a hitch removably connected to said lower portion.

7. The multi-use enclosure of claim 1 further comprising an axle integrated into said lower portion.

8. A multi-use enclosure comprising:
an upper portion operably connected to a lower portion;
a ballast compartment integrated into said lower portion;
a power storage device operably connected to said lower portion;
a control unit operably connected to said power storage device and to a network;
a communication unit operably connected to said control unit and said network, said communication unit being configured to receive and transmit information to a remote device operably connected to said network; and
position sensors positioned within said multi-use enclosure and configured to detect a vehicle's position within said multi-use enclosure.

9. The multi-use enclosure of claim 8 wherein said upper portion comprises a roof section removably connected to a wall section, wherein said roof section is of a shape and size that allows for floatation when flipped up-side down.

10. The multi-use enclosure of claim 8 wherein said upper portion comprises a center member connected to said lower portion and to two half-shell sections via hinge mechanisms such that each half-shell section may be raised away from said lower section while remaining connected to said center member.

11. The multi-use enclosure of claim 8 further comprising a heating/cooling unit configured to provide heating and/or cooling to the interior of said multi-use enclosure.

12. The multi-use enclosure of claim 8 further comprising an electricity generating device mounted to said upper portion and operably connected to said power storage device.

13. The multi-use enclosure of claim 8 further comprising a hitch removably connected to said lower portion.

14. The multi-use enclosure of claim 8 further comprising an axle integrated into said lower portion.

15. A method of making a multi-use enclosure comprising the steps:
connecting an upper portion to a lower portion via a hinge mechanism;
integrating a ballast compartment into said lower portion;
connecting a power storage device to said lower portion;
connecting a control unit to said power storage device and to a network; and
connecting a communication unit to said control unit and said network, said communication unit being configured to receive and transmit information to a remote device operably connected to said network.

16. The method of claim 15 wherein said upper portion comprises a roof section removably connected to a wall section, wherein said roof section is of a shape and size that allows for floatation when flipped up-side down.

17. The method of claim 15 wherein said upper portion comprises a center member connected to said lower portion and to two half-shell sections via hinge mechanisms such that each half-shell section may be raised away from said lower section while remaining connected to said center member.

18. The method of claim 15 further comprising connecting an electricity generating device mounted to said upper portion and to said power storage device.

19. The method of claim 15 further comprising connecting a hitch to said lower portion.

20. The method of claim 15 further comprising connecting a winch system to said lower section.
